(19) United States
(12) Patent Application Publication
(10) Pub. No.: US 2024/0004525 A1
(43) Pub. Date: Jan. 4, 2024

(54) TELEPROMPTER SYSTEM AND OPERATION METHOD

(71) Applicants: Beijing BOE Optoelectronics Technology Co., Ltd., Beijing (CN); BOE Technology Group Co., Ltd., Beijing (CN)

(72) Inventors: Jinghua MIAO, Beijing (CN); Yanqiu ZHAO, Beijing (CN); Qingwen FAN, Beijing (CN); Wenyu LI, Beijing (CN); Lili CHEN, Beijing (CN); Hao ZHANG, Beijing (CN)

(21) Appl. No.: 18/038,727

(22) PCT Filed: Nov. 27, 2020
(86) PCT No.: PCT/CN2020/132445

§ 371 Date: May 25, 2023

(51) Int. Cl. G06F 3/0483; G06F 3/01

(52) U.S. Cl. CPC G06F 3/0483; G06F 3/013

(57) ABSTRACT

Provided are a teleprompter system and an operation method. The teleprompter system includes a display, an eye tracker and a processor. The processor acquires a page-turning trigger signal and processes the page-turning trigger signal to obtain an indication signal; according to the indication signal, the processor switches a content page that is currently displayed by the display to a target page, and the display displays the target page. The page-turning trigger signal includes at least one of the following signals: a first trigger signal sent by a page-turning terminal that is in communication connection with the teleprompter system; or a second trigger signal sent from the eye tracker.

### CROSS-REFERENCE TO RELATED APPLICATIONS

The disclosure is a National Stage of International Application No. PCT/CN2020/132445, filed on Nov. 27, 2020, which is hereby incorporated by reference in their entireties.

### FIELD

The present disclosure relates to the technical field of prompt, and particularly to a teleprompter system and an operation method.

### BACKGROUND

In the traditional teleprompter, script content is displayed by a high-brightness display device and then reflected to a piece of special-purpose coated glass inclined at 45 degrees in front of a lens of a camera, so as to reflect speeches. In this way, a speaker can face the camera while watching the speeches. Being large-sized, the traditional teleprompter is required to be fixed at a specific position, which limits the speaker to a narrow range.

An existing augmented reality (AR) teleprompter has a problem in synchronous correspondence between prompt content and presentation content.

### SUMMARY

The present disclosure provides a teleprompter system and an operation method. Specific solutions are as follows.

An embodiment of the present disclosure provides a teleprompter system. The teleprompter system includes a display, an eye tracker and a processor; and the processor is configured to:
obtain a page-turning trigger signal, and process the page-turning trigger signal to obtain an indication signal;
according to the indication signal, switch a content page that is currently displayed by the display to a target page, where the target page is displayed in the display;
where the page-turning trigger signal includes at least one of:
a first trigger signal from a page-turning terminal in communication connection with the teleprompter system; or
a second trigger signal from the eye tracker.

Optionally, in an embodiment of the present disclosure, in a case that the page-turning trigger signal is the second trigger signal, the processor configured to obtain the page-turning trigger signal, and process the page-turning trigger signal to obtain the indication signal is configured to:
obtain the second trigger signal, and determine a coordinate position of a coordinate point at which eyes of a user watch the content page;
determine a coordinate position of at least one feature coordinate point corresponding to the content page;
detect whether a distance between the coordinate position of the coordinate point at which the eyes of the user watch the content page and the coordinate position of the at least one feature coordinate point is less than a preset distance threshold; and
generate, in a case that the distance is less than the preset distance threshold, the indication signal for switching the content page to the target page.

Optionally, in an embodiment of the present disclosure, the processor configured to determine the coordinate position of the at least one feature coordinate point corresponding to the content page is configured to:
determine at least one line of text content of the content page; and
determine start and stop coordinate point positions and an intermediate coordinate point position of the at least one line of text content, and take the start and stop coordinate point positions and the intermediate coordinate point position as the coordinate positions of the at least one feature coordinate point.

Optionally, in an embodiment of the present disclosure, the processor configured to determine the coordinate position of the at least one feature coordinate point corresponding to the content page is configured to:
determine a last line of text content of the content page; and
determine at least one preset coordinate point position of the last line of text content, and take the at least one preset coordinate point position as the coordinate position of the at least one feature coordinate point.

Optionally, in an embodiment of the present disclosure, after the processor is configured to determine the at least one preset coordinate point position of the last line of text content, and take the at least one preset coordinate point position as the coordinate position of the at least one feature coordinate point, the processor is further configured to: scroll the last line of text content of the content page to a first line of text content of the target page.

Optionally, in an embodiment of the present disclosure, the processor configured to determine the coordinate position of the at least one feature coordinate point corresponding to the content page is configured to:
determine at least one key word on the content page and at least one coordinate position of the at least one key word on the content page, and take the at least one coordinate position as the coordinate position of the at least one feature coordinate point.

Optionally, in an embodiment of the present disclosure, after the processor is configured to detect whether the distance between the coordinate position of the coordinate point at which the eyes of the user watch the content page and the coordinate position of the at least one feature coordinate point is less than the preset distance threshold, the processor is further configured to:
determine the coordinate position having the distance less than the preset distance threshold in coordinate point positions at which the eyes of the user watch the content page; and
generate, in a case that the coordinate point positions at which the eyes of the user watch the content page include a coordinate position of a last coordinate point in the content page, the coordinate position of the last coordinate point has a distance less than the preset distance threshold with the coordinate position of the at least one feature coordinate point, and the number of the coordinate positions having the distances less than the preset distance threshold in the coordinate point positions at which the eyes of the user watch the content page is greater than a preset number, the indication signal for switching the content page to the target page.

Optionally, in an embodiment of the present disclosure, in a case that the page-turning trigger signal is the second trigger signal, the processor configured to obtain the page-turning trigger signal, and process the page-turning trigger signal to obtain the indication signal is configured to:
obtain the second trigger signal, and determine a coordinate point position at which eyes of a user watch the content page;
detect whether the coordinate point position is in a first preset region;
detect, in a case that the coordinate point position is in the first preset region, whether a watching duration in which the eyes of the user watch the first preset region is longer than a preset duration; and
generate, in a case that the watching duration is longer than the preset duration, the indication signal for switching the content page to the target page.

Optionally, in an embodiment of the present disclosure, the processor configured to obtain the page-turning trigger signal and process the page-turning trigger signal to obtain an indication signal is configured to:
measure an interval of consecutively obtaining the page-turning trigger signal twice;
count, in a case that the interval is less than a preset duration, the number of times of triggering of the page-turning trigger signal until no page-turning trigger signal is detected within the preset duration;
determine the target page corresponding to the number of times of triggering of page turning according to the number of times of triggering of the page-turning trigger signal; and
generate the indication signal for switching the content page to the target page.

Optionally, in an embodiment of the present disclosure, in a case that the page-turning trigger signal includes the first trigger signal and the second trigger signal, the processor configured to obtain the page-turning trigger signal and process the page-turning trigger signal to obtain the indication signal is configured to:
process the first trigger signal, and generate the indication signal for switching the content page to the target page.

Accordingly, an embodiment of the present disclosure further provides an operation method for a teleprompter system. The method includes:
obtaining a page-turning trigger signal by a processor, and processing the page-turning trigger signal to obtain an indication signal;
switching, by the processor according to the indication signal, a content page that is currently displayed by a display to a target page; and
displaying the target page by the display;
where the page-turning trigger signal includes at least one of:
a first trigger signal from a page-turning terminal in communication connection with the teleprompter system; and
a second trigger signal from an eye tracker.

Optionally, in an embodiment of the present disclosure, in a case that the page-turning trigger signal is the second trigger signal, the obtaining a page-turning trigger signal by a processor, and the processing the page-turning trigger signal to obtain an indication signal include:
obtaining the second trigger signal by the processor, and determining a coordinate position of a coordinate point at which eyes of a user watch the content page;
determining a coordinate position of at least one feature coordinate point corresponding to the content page;
detecting whether a distance between the coordinate position of the coordinate point at which the eyes of the user watch the content page and the coordinate position of the at least one feature coordinate point is less than a preset distance threshold, and
generating, in a case that the distance is less than the preset distance threshold, the indication signal for switching the content page to the target page.

Optionally, in an embodiment of the present disclosure, the determining a coordinate position of at least one feature coordinate point corresponding to the content page includes:
determining at least one line of text content of the content page; and
determining start and stop coordinate point positions and an intermediate coordinate point position of the at least one line of text content, and taking the start and stop coordinate point positions and the intermediate coordinate point position as the coordinate positions of the at least one feature coordinate point.

Optionally, in an embodiment of the present disclosure, the determining a coordinate position of at least one feature coordinate point corresponding to the content page includes:
determining a last line of text content of the content page; and
determining at least one preset coordinate point position of the last line of text content, and taking the at least one preset coordinate point position as the coordinate position of the at least one feature coordinate point.

Optionally, in an embodiment of the present disclosure, after determining at least one preset coordinate point position of the last line of text content, and the taking the at least one preset coordinate point position as the coordinate position of the at least one feature coordinate point, the method further include:
scrolling the last line of text content of the content page to a first line of text content of the target page.

Optionally, in an embodiment of the present disclosure, the determining a coordinate position of at least one feature coordinate point corresponding to the content page includes:
determining at least one key word of the content page and at least one coordinate position of the at least one key word on the content page, and taking the at least one coordinate position as the coordinate position of the at least one feature coordinate point.

Optionally, in an embodiment of the present disclosure, after detecting whether a distance between the coordinate position of the coordinate point at which the eyes of the user watch the content page and the coordinate position of the at least one feature coordinate point is less than a preset distance threshold, the method further includes:
determining the coordinate position having the distance less than the preset distance threshold in coordinate point positions at which the eyes of the user watch the content page; and
generating, in a case that the coordinate point positions at which the eyes of the user watch the content page include a coordinate position of a last coordinate point in the content page, the coordinate position of the last coordinate point has a distance less than the preset distance threshold with the coordinate position of the at least one feature coordinate point, and the number of the coordinate positions having the distances less than the preset distance threshold in the coordinate point positions at which the eyes of the user watch the content page is greater than a preset number, the indication signal for switching the content page to the target page.

Optionally, in an embodiment of the present disclosure, in a case that the page-turning trigger signal is the second trigger signal, the obtaining a page-turning trigger signal by a processor, and the processing the page-turning trigger signal to obtain an indication signal include:
obtaining the second trigger signal by the processor, and determining a coordinate point position at which eyes of a user watch the content page;
detecting whether the coordinate point position is in a first preset region;
detecting, in a case that the coordinate point position is in the first preset region, whether a watching duration in which the eyes of the user watch the first preset region is longer than a preset duration; and
generating, in a case that the watching duration is longer than the preset duration, the indication signal for switching the content page to the target page.

Optionally, in an embodiment of the present disclosure, the obtaining a page-turning trigger signal by a processor, and the processing the page-turning trigger signal to obtain an indication signal include:
measuring, by the processor, an interval of consecutively obtaining the page-turning trigger signal twice;
counting, in a case that the interval is less than a preset duration, the number of times of triggering of the page-turning trigger signal until no page-turning trigger signal is detected within the preset duration;
determining the target page corresponding to the number of times of triggering of page turning according to the number of times of triggering of the page-turning trigger signal; and
generating the indication signal for switching the content page to the target page.

Optionally, in an embodiment of the present disclosure, in a case that the page-turning trigger signal includes the first trigger signal and the second trigger signal, the obtaining a page-turning trigger signal by a processor, and the processing the page-turning trigger signal to obtain an indication signal include:
processing the first trigger signal by the processor, and generating the indication signal for switching the content page to the target page.

### BRIEF DESCRIPTION OF THE DRAWING

FIG. 1 is a structural block diagram of a teleprompter system according to an embodiment of the present disclosure.

FIG. 2 is a schematic diagram of a content page in a teleprompter system according to an embodiment of the present disclosure.

FIG. 3 is a schematic diagram of feature coordinate points of a content page in a teleprompter system according to an embodiment of the present disclosure.

FIG. 4 is another schematic diagram of feature coordinate points of a content page in a teleprompter system according to an embodiment of the present disclosure.

FIG. 5 is another schematic diagram of feature coordinate points of a content page in a teleprompter system according to an embodiment of the present disclosure.

FIG. 6 is another schematic diagram of a content page in a teleprompter system according to an embodiment of the present disclosure.

FIG. 7 is a flow diagram of an operation method for a teleprompter system according to an embodiment of the present disclosure.

FIG. 8 is a flow diagram of step S101 in an operation method for a teleprompter system according to an embodiment of the present disclosure.

FIG. 9 is a flow diagram of a first implementation mode of step S202 in an operation method for a teleprompter system according to an embodiment of the present disclosure.

FIG. 10 is a flow diagram of a second implementation mode of step S202 in an operation method for a teleprompter system according to an embodiment of the present disclosure.

FIG. 11 is a flow diagram after step S203 in an operation method for a teleprompter system according to an embodiment of the present disclosure.

FIG. 12 is a flow diagram of step S101 in an operation method for a teleprompter system according to an embodiment of the present disclosure.

FIG. 13 is a flow diagram of step S101 in an operation method for a teleprompter system according to an embodiment of the present disclosure.

### DETAILED DESCRIPTION OF THE EMBODIMENTS

In order to make objectives, technical solutions and advantages of embodiments of the present disclosure clearer, technical solutions in the embodiments of the present disclosure will be clearly and completely described below in combination with accompanying drawings in the embodiments of the present disclosure. Apparently, the described embodiments are merely some embodiments rather than all embodiments of the present disclosure. In addition, embodiments of the present disclosure and features in the embodiments can be combined with each other without conflict. On the basis of the described embodiments of the present disclosure, all other embodiments obtained by those of ordinary skill in the art without making creative efforts all fall within the scope of protection of the present disclosure.

Unless otherwise defined, technical terms or scientific terms used in the present disclosure should have the ordinary meanings understood by those of ordinary skill in the art to which the present disclosure belongs. “Comprise”, “include” or other similar words used in the present disclosure mean that an element or object appearing before the word contains elements or objects listed after the word and its equivalents, without excluding other elements or objects.

An existing teleprompter has the problem of synchronous correspondence between prompt content and presentation content.

In view of this, embodiments of the present disclosure provide a teleprompter system and an operation method, which are used for implementing a synchronous correspondence between prompt content and presentation content.

As shown in FIG. 1, a teleprompter system provided in an embodiment of the present disclosure is shown. The teleprompter system includes a display 1, an eye tracker 2 and a processor 3; where the processor 3 is configured to:
obtain a page-turning trigger signal, and process the page-turning trigger signal to obtain an indication signal;
switch a content page that is currently displayed by the display 1 to a target page according to the indication signal, where the target page is displayed in the display 1;
where the page-turning trigger signal includes at least one of: a first trigger signal sent from a page-turning terminal in communication connection with the teleprompter system; or a second trigger signal sent from the eye tracker 2.

In a specific implementation process, the teleprompter system is preferably a wearable device, such as augmented reality (AR) glasses, or a mobile terminal, which is not limited herein. The eye tracker 2 may include an eye sensing module and an eye tracking module, the eye sensing module may be an infrared light emitting diode (LED) lamp, and the eye tracking module may be an infrared camera or a micro-electro-mechanical system (MEMS). Those skilled in the art may set a specific structure of the eye tracker 2 according to actual application requirements, which is not limited herein. In addition, the eye tracking module may be arranged on the wearable device, or may be arranged in a background host of the teleprompter system, which is not limited herein.

In a specific implementation process, the page-turning trigger signal obtained by the processor 3 may include a first trigger signal sent from a page-turning terminal in communication connection with the teleprompter system, and the page-turning terminal may be a presenter or a laser page-turning pen. When the page-turning terminal is the presenter, the presenter may be a personal computer, a smart screen, a mobile terminal, etc. In a case the page-turning terminal is the laser page-turning pen, the laser page-turning pen may be composed of a radio frequency remote control and a receiver, a wireless radio frequency transmitter is embedded in the radio frequency remote control, and the receiver may be inserted into a universal serial bus (USB) interface of the presenter. Normal operation may be implemented without mounting a driver in the presenter, and a user may operate the receiver only by operating relevant function keys of the radio frequency remote control, so as to carry out page turning on the presenter by the laser page-turning pen, and further turn a content page that is currently displayed on a display screen in the teleprompter system by carrying out page turning on the presenter. In addition, during practical application, in a case that the page-turning terminal is the laser page-turning pen, the receiver may be inserted into the USB interface of the teleprompter system, for example, inserted into a USB interface of a display screen. Normal operation may be implemented without mounting a driver in the teleprompter system, and a user may operate the receiver only by operating relevant function keys of the radio frequency remote control, so as to turn a content page that is currently displayed on the display screen in the teleprompter system by the laser page-turning pen. A synchronous correspondence between presentation content and prompt content is implemented, and further quick page turning is carried out on the teleprompter system.

In a specific implementation process, the page-turning trigger signal obtained by the processor 3 may further include the second trigger signal sent from the eye tracker 2. Accordingly, the page-turning trigger signal may include only the first trigger signal, or only the second trigger signal, or the first trigger signal and the second trigger signal. No matter whether the page-turning trigger signal obtained by the processor 3 is the first trigger signal sent from the page-turning terminal or the second trigger signal sent from the eye tracker 2, the processor 3 may process the page-turning trigger signal to obtain an indication signal. Then, according to the indication signal, the processor 3 switches the content page that is currently displayed by the display 1 to a target page, and after switching, the display 1 displays the target page. Therefore, the content page that is currently displayed on the display screen of the teleprompter system may be switched through different methods, a synchronous correspondence between presentation content and prompt content is implemented, and page-turning efficiency is improved.

In an embodiment of the present disclosure, in a case that the page-turning trigger signal is the second trigger signal, the processor 3 configured to obtain the page-turning trigger signal, and process the page-turning trigger signal to obtain the indication signal is configured to:
obtain the second trigger signal, and determine a coordinate position of a coordinate point at which eyes of a user watch the content page;
determine a coordinate position of at least one feature coordinate point corresponding to the content page;
detect whether a distance between the coordinate position of the coordinate point at which the eyes of the user watch the content page and the coordinate position of the at least one feature coordinate point is less than a preset distance threshold; and
generate, in a case that the distance is less than the preset distance threshold, the indication signal for switching the content page to the target page.

In a specific implementation process, in a case that the page-turning trigger signal is the second trigger signal, that is, the processor 3 obtains the second trigger signal sent from the eye tracker 2. Specifically, the processor 3 may obtain a coordinate position of a coordinate point at which the eyes of a user watch the content page that is currently displayed by the display 1, and determine a coordinate position of at least one feature coordinate point corresponding to the content page. During actual application, a coordinate position of at least one feature coordinate point in each content page in the display 1 of the teleprompter system may be preset, and the coordinate positions of the feature coordinate points in content pages in the display 1 may be the same or different.

After obtaining the coordinate position of the coordinate point at which the eyes of the user watch the content page and the coordinate position of the at least one feature coordinate point corresponding to the content page, the processor 3 detects whether the distance between the coordinate position of the coordinate point at which the eyes of the user watch the content page and the coordinate position of the at least one feature coordinate point is less than the preset distance threshold. The preset distance threshold may be a value that is preset, for example, sj, or may be a value set according to actual application requirements. In a case that the distance between the coordinate position of the coordinate point at which the eyes of the user watch the content page and the coordinate position of the at least one feature coordinate point is less than the preset distance threshold, an indication signal for switching the content page to a target page is generated. In this way, the processor 3 may switch the content page to the target page according to the indication signal. Where the content page and the target page are two consecutive pages. For a specific example, a coordinate position of a certain feature coordinate point of the content page is (x0, y0), a position of the coordinate point at which the eyes of the user watch the content page is (x1, y1), the preset distance threshold is sj, and in a case of |x0−x1|<sj and |y0−y1|<sj, it is indicated that the eyes of the user have browsed the coordinate position of the feature coordinate point. Through the same detection method, in a case that the eyes of the user have browsed coordinate positions of all feature coordinate points in the content page, the content page is switched to the target page. In this way, in a whole page-turning process, a page may be turned only through an operation that the eyes of the user watch a content page that is currently displayed by the display 1, so that the page-turning operation is simplified, and page-turning efficiency is relatively high. Even when one presentation page in the presenter corresponds to a plurality of content pages in the display 1, page turning may be carried out on the teleprompter system still through the method that the eyes of the user watch coordinate positions of feature coordinate points in the content pages. A synchronous correspondence between presentation content and prompt content is implemented, and overall page-turning efficiency is relatively high.

In an embodiment of the present disclosure, the processor 3 may determine the coordinate position of the at least one feature coordinate point corresponding to the content page through the following method. Specifically, the processor 3 configured to determine the coordinate position of the at least one feature coordinate point corresponding to the content page is configured to:
determine at least one line of text content of the content page; and
determine start and stop coordinate point positions and an intermediate coordinate point position of the at least one line of text content, and take the start and stop coordinate point positions and the intermediate coordinate point position as the coordinate positions of the at least one feature coordinate point.

In a specific implementation process, the at least one line of text content of the content page may be one line of text content, or a plurality of lines of text content, which is not limited herein. After the processor 3 determines the at least one line of text content of the content page, the processor 3 may determine the start and stop coordinate point positions and the intermediate coordinate point position of the at least one line of text content. In a case that the at least one line of text content is one line of text content, the start and stop coordinate point positions include a start coordinate point position and a stop coordinate point position of the one line of text content, and the intermediate coordinate point position is a coordinate point position located in an intermediate position between the start coordinate point position and the stop coordinate point position. Accordingly, the start and stop coordinate point positions and the intermediate coordinate point position are taken as the coordinate positions of the at least one feature coordinate point.

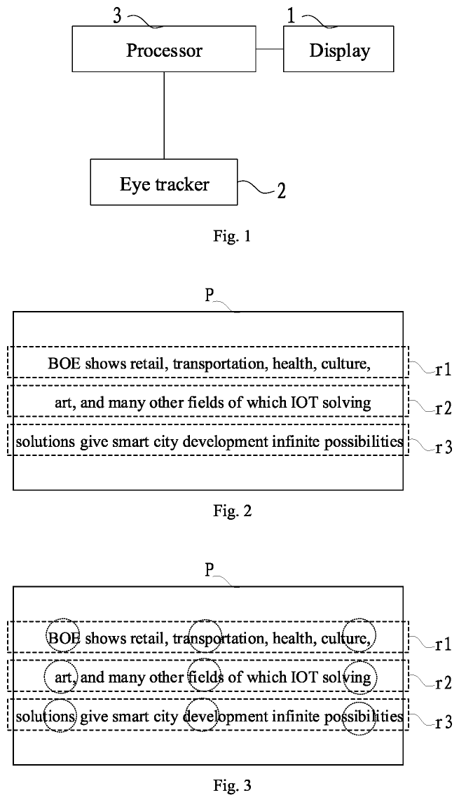

In addition, in a case that the at least one line of text content is a plurality of lines of text content, start and stop coordinate point positions and an intermediate coordinate point position of each of the lines of text content in the content page may be all taken as the coordinate positions of the at least one feature coordinate point. Taking a content page P shown in FIG. 2 as an example, the content page P includes three lines of text content: an r1 line of text content, an r2 line of text content and an r3 line of text content. The text content of the content page P is “Internet of things solutions in a plurality of fields of retail, transportation, health, culture, art, etc. shown by BOE bring infinite possibilities for smart city development”, the r1 line of text content is “Internet of things solutions in a plurality of fields of retail”, the r2 line of text content is “transportation, health, culture, art, etc. shown by BOE”, and the r3 line of text content is “bring infinite possibilities for smart city development”. Start and stop coordinate point positions and an intermediate coordinate point position in each line of text content are as shown in FIG. 3, and specific positions am marked by circles in FIG. 3. The start and stop coordinate point positions of the r1 line of text content are coordinate point positions corresponding to “Internet” and “retail” respectively, and the intermediate coordinate point position of the r1 line of text content is a coordinate point position corresponding to “in a”. The start and stop coordinate point positions of the r2 line of text content are coordinate point positions corresponding to “transportation” and “BOE” respectively, and the intermediate coordinate point position of the r2 line of text content is a coordinate point position corresponding to “culture”. The start and stop coordinate point positions of the r3 line of text content are coordinate point positions corresponding to “bring” and “development” respectively, and the intermediate coordinate point position of the r3 line of text content is a coordinate point position corresponding to “for”.

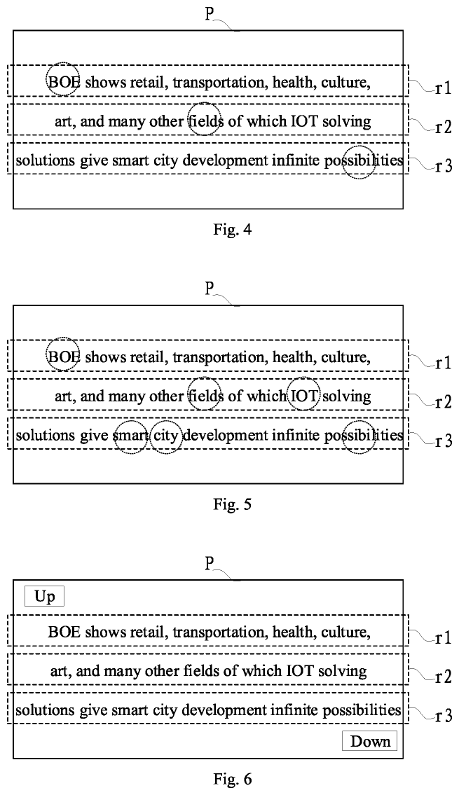

In a specific implementation process, in a case that the at least one line of text content is a plurality of lines of text content, start and stop coordinate point positions and intermediate coordinate point positions in certain lines of text content in the plurality of lines of text content may be taken as the coordinate positions of the at least one feature coordinate point. Still taking the content page shown in FIG. 2 as an example, in a case that start and stop coordinate point positions and an intermediate coordinate point position of three lines of text content are taken as the coordinate positions of the at least one feature coordinate point, the coordinate point positions of the at least one feature coordinate point in the content page P are as shown in FIG. 4, and specific positions are marked by circles in FIG. 4. The start and stop coordinate point positions of the r1, r2 and r3 lines of text content are coordinate point positions corresponding to “Internet” and “development” respectively, and the intermediate coordinate point position of the r1, r2 and r3 lines of text content is a coordinate point position corresponding to “culture”. In this way, after the coordinate positions of the at least one feature coordinate point corresponding to the content page are determined, distances between the coordinate position of the coordinate point at which eyes of a user watch the content page and the coordinate positions of the at least one feature coordinate point may be compared with a preset distance threshold. Therefore, a page may be turned by comparing the feature coordinate points when the eyes of the user watch the content page, a synchronous correspondence between presentation content and prompt content is implemented, and page-turning efficiency is improved.

In an embodiment of the present disclosure, the processor 3 may determine the coordinate position of the at least one feature coordinate point corresponding to the content page through the following method. Specifically, the processor 3 configured to determine the coordinate position of the at least one feature coordinate point corresponding to the content page is configured to:
determine a last line of text content of the content page; and
determine at least one preset coordinate point position of the last line of text content, and take the at least one preset coordinate point position as the coordinate position of the at least one feature coordinate point.

In a specific implementation process, the processor 3 may determine the last line of text content of the content page. Still taking the content page shown in FIG. 2 as an example, the last line of text content corresponds to r3. The processor 3 determines at least one preset coordinate point position of the last line of text content, and takes the at least one preset coordinate point position as the coordinate position of the at least one feature coordinate point. The at least one preset coordinate point position may be a stop coordinate point position in the last line of text content, or an intermediate coordinate point position and a stop coordinate point position in the last line of text content, or a coordinate point position that is set according to other rules, which is not limited herein. In a case that the at least one preset coordinate point position is a stop coordinate point position in the last line of text content, once the distance between the coordinate position of the coordinate point at which the eyes of the user watch the content page and the stop coordinate point position is less than the preset distance threshold, the content page is switched to a target page. The content page and the target page are two consecutive pages. For example, when the eyes of the user watch the word “development” at the stop coordinate point position of the last line of text content r3 shown in FIG. 2, the content page is switched to a target page, for example, switched to a next page of the content page. By determining the coordinate position of the at least one feature coordinate point from the last line of text content of the content page, the processor 3 may fast turn the content page only by comparing the coordinate position of the at least one feature coordinate point in the last line of text content, and the page is turned after the eyes of the user watch the last line of text content of the content page, which more conforms to usage experience of the user.

In an embodiment of the present disclosure, after the processor 3 is configured to determine the at least one preset coordinate point position of the last line of text content, and take the at least one preset coordinate point position as the coordinate position of the at least one feature coordinate point, the processor 3 is further configured to: scroll the last line of text content of the content page to a first line of text content of the target page.

In a specific implementation process, after the processor 3 takes the at least one preset coordinate point position in the last line of text content as the coordinate position of the at least one feature coordinate point of the content page, in a case that the distance between the coordinate position of the coordinate point at which the eyes of the user watch the content page and the at least one preset coordinate point position is less than the preset distance threshold, the processor 3 may scroll the last line of text content of the content page to the first line of text content of the target page. The content page and the target page are two consecutive pages, thereby achieving turning the content page through scrolling, and improving usage experience of the user.

In an embodiment of the present disclosure, the processor 3 may determine the coordinate position of the at least one feature coordinate point corresponding to the content page through the following method. Specifically, the processor 3 configured to determine the coordinate position of the at least one feature coordinate point corresponding to the content page is configured to:
determine at least one key word on the content page and at least one coordinate position of the at least one key word on the content page, and take the at least one coordinate position as the coordinate position of the at least one feature coordinate point.

In a specific implementation process, the key word of the content page may be manually preset according to actual application requirements. For example, when the text content in the content page is known, the key word in the content page is manually set. In addition, the key word of the content page may further be automatically determined according to a set rule, for example, the key word is determined by setting rules of human names and place names. According to these rules, the key word may be automatically determined from the content page that is currently displayed by the display 1. Certainly, those skilled in the art may set other rules for determining key words according to actual application requirements, which will not be described in detail herein. The key words may be words and expressions, which are not limited herein.

The processor 3 may determine the at least one key word of the content page and at least one coordinate position of the at least one key word on the content page, and there may be one or more key words. In a case of one key word, there is one coordinate position, and in a case of a plurality of key words, there are a plurality of coordinate positions. In a specific implementation process, at least one coordinate position of the at least one key word on the content page may be taken as the coordinate position of the at least one feature coordinate point. Still taking the content page shown in FIG. 2 as an example for description, the coordinate positions of the key words in the content page P may be in a situation as shown in FIG. 5, specifically, may be positions marked by circles in FIG. 5, and the key words in the content page P are “Internet of things”, “fields”, “BOE”, “possibilities”, “smart” and “city”. Certainly, the key words may be set in other forms besides that in FIG. 5, which is not limited herein.

In a specific implementation process, after determining the at least one coordinate position of the at least one key word of the content page, the processor 3 detects whether the distance between the coordinate position of the coordinate point at which the eyes of the user watches the content page and the at least one coordinate position is less than the preset distance threshold. In a case that the distance between the coordinate position of the coordinate point at which the eyes of the user watch the content page and the at least one coordinate position is less than the preset distance threshold, the content page is switched to the target page, thereby achieving turning the content page through an operation that the eyes of the user watch the key word in the content page. Since the key words more conform to a usage habit of the user, the operation that the page is turned after the user browses the key words in the content page is higher in page-turning efficiency, and more conforms to usage experience of the user.

In an embodiment of the present disclosure, after the processor 3 is configured to detect whether the distance between the coordinate position of the coordinate point at which the eyes of the user watch the content page and the coordinate position of the at least one feature coordinate point is less than a preset distance threshold, the processor is further configured to:
determine the coordinate position having the distance less than the preset distance threshold in coordinate point positions at which the eyes of the user watch the content page; and
generate the indication signal for switching the content page to the target page, in a case that the coordinate point positions at which the eyes of the user watch the content page include a coordinate position of a last coordinate point in the content page, the coordinate position of the last coordinate point has a distance less than the preset distance threshold with the coordinate position of the at least one feature coordinate point, and the number of the coordinate positions having the distances less than the preset distance threshold in the coordinate point positions at which the eyes of the user watch the content page is greater than a preset number.

In a specific implementation process, after the processor 3 detects whether the distance between the coordinate point positions at which the eyes of the user watch the content page and the coordinate position of the at least one feature coordinate point is less than the preset distance threshold, the processor 3 determines the coordinate position having the distance less than the preset distance threshold in the coordinate point positions at which the eyes of the user watch the content page. For example, there are eight coordinate positions of the at least one feature coordinate point, and distances between seven coordinate positions and the coordinate point position at which the eyes of the user watch the content page are less than the preset distance threshold. In a case that the coordinate point positions at which the eyes of the user watch the content page include the last coordinate point position in the content page, and the coordinate position of the last coordinate point has the distance less than the preset distance threshold with the coordinate position of the at least one feature coordinate point, for example, the eyes of the user watch the coordinate position of the last coordinate point, and the distance between the coordinate position of the last coordinate point and the coordinate position of the last coordinate point in the above seven coordinate positions is less than the preset distance threshold; and in a case that the number of the coordinate positions having the distances less than the preset distance threshold in the coordinate point positions of the content page at which the eyes of the user watch the content page is greater than the preset number, an indication signal for switching the content page to the target page is generated. In this way, the processor 3 may switch the content page to the target page according to the indication signal, and the content page and the target page are two consecutive pages. The preset number is the number that is preset according to actual application requirements. Still taking the above example as an example, in a case that the preset number is six, the distances between the seven coordinate positions and the coordinate point position at which the eyes of the user watch the content page are less than the preset distance threshold, and the coordinate position of the last coordinate point in the seven coordinate positions is the coordinate position of the last coordinate point of the content page, the processor 3 switches the content page to the target page. During practical application, as long as the distance between the coordinate position of the coordinate point at which the eyes of the user watch the content page and the coordinate position of the last coordinate point is less than the preset distance threshold, and the number of the coordinate positions having the distances less than the preset distance threshold is greater than the preset number, the content page may be switched. Therefore, a synchronous correspondence between presentation content and prompt content is implemented, the content page may be switched without the need for a user to watch all of the at least one feature coordinate point, and page-turning efficiency is improved.

In an embodiment of the present disclosure, in addition to the above-mentioned operation that the distance between the coordinate position of the coordinate point at which the eyes of the user watch the content page and the coordinate position of the at least one feature coordinate point corresponding to the content page is compared with the preset distance threshold to switch the content page to the target page, trajectory fitting may be carried out on the coordinate positions of the coordinate points at which the eyes of the user watch the content page. The processor 3 compares a fitted trajectory with a preset browsing trajectory corresponding to the content page, and if the fitted trajectory matches the preset browsing trajectory, the content page is switched to the target page. The content page and the target page are two consecutive pages. In a specific implementation process, the preset browsing trajectory may be a trajectory fitted according to the coordinate positions of the at least one feature coordinate point of the content page, and more conforms to a usage habit of browsing the content page of the user, so that the content page is switched by watching a trajectory, a whole page-turning process more conforms to a usage habit of the user, and user experience is considered.

In an embodiment of the present disclosure, in a case that the page-turning trigger signal is the second trigger signal, the processor 3 configured to obtain the page-turning trigger signal, and process the page-turning trigger signal to obtain the indication signal is configured to:
obtain the second trigger signal, and determine a coordinate point positions at which eyes of a user watch the content page;
detect whether the coordinate point position is in a first preset region;
detect, in a case that the coordinate point position is in the first preset region, whether a watching duration in which the eyes of the user watch the first preset region is longer than a preset duration; and
generate, in a case that the watching duration is longer than the preset duration, the indication signal for switching the content page to the target page.

In a specific implementation process, in a case that the page-turning trigger signal is the second trigger signal, that is, the processor 3 obtains the second trigger signal sent from the eye tracker 2. Specifically, the processor 3 obtains the second trigger signal, determines the coordinate point position at which the eyes of the user watch the content page, and detects whether the coordinate point position is in the first preset region. The first preset region is used for representing a region of a page-turning function, and the page-turning function may be up or down. The first preset region may be an upper left corner region of the content page, and may also be a lower right corner region of the content page. Still taking the content page as shown in FIG. 2 as an example, FIG. 6 shows a type of schematic diagram of the first preset region including an up function and a down function. In a case that the coordinate point position at which the eyes of the user watch the content page is in the first preset region, whether the watching duration in which the eyes of the user watch the first preset region is greater than the preset duration is detected. The preset duration is a duration that is preset according to a usage habit of the user, for example, 2S. In a case that the watching duration is greater than the preset duration, the indication signal for switching the content page to the target page is generated. In this way, the processor 3 may switch the content page to the target page according to the indication signal. The content page and the target page are two consecutive pages. Therefore, the content page is turned by watching the first preset region for representing a page-turning function, a whole page-turning process more conforms to the usage habit of the user, page-turning accuracy is higher, and page-turning efficiency is higher. In addition, through the method for turning a page through watching shown in FIG. 6, the current content page may be turned without comparing feature coordinate points in the current content page. A synchronous correspondence between presentation content and prompt content is implemented, and overall page-turning accuracy is higher. Even in a process that a presenter turns the content page by a page-turning laser pen, in a case that a page may not be turned on time due to a relatively large network delay, the current content page may still be turned through watching, and therefore prompt page-turning efficiency is further ensured.

In an embodiment of the present disclosure, the processor configured to obtain the page-turning trigger signal, and process the page-turning trigger signal to obtain the indication signal is configured to:
measure an interval of continuously obtaining the page-turning trigger signal twice;
count, in a case that the interval is less than a preset duration, the number of times of triggering of the page-turning trigger signal until no page-turning trigger signal is detected within the preset duration;
determine the target page corresponding to the number of times of triggering of page turning according to the number of times of triggering of the page-turning trigger signal; and
generate the indication signal for switching the content page to the target page.

In a specific implementation process, the processor 3 measures the interval of consecutively obtaining the page-turning trigger signal twice, that is, the processor 3 records moments of consecutively obtaining the page-turning trigger signal twice, and determines the interval, for example, Δt of consecutively obtaining the page-turning trigger signal twice according to the obtained moments. In a case that the interval is less than the preset duration, the number of times of triggering of the page-turning trigger signal is counted. Accordingly, the display 1 enters a fast page-turning mode until no page-turning trigger signal is detected within the preset duration. Accordingly, the display 1 stops fast turning a page, and the processor 3 controls the display 1 to exit the fast page-turning mode. The preset duration may be the duration that is set according to an actual page-turning habit of a user. For example, the preset duration is set as T, and in a case that the interval duration is less than the preset duration, the display 1 is controlled to enter the fast page-turning mode. For another example, in a case that the interval is less than the preset duration, and the number of times of triggering of the page-turning trigger signal from the presenter is 2, the processor 3 only carries out fast page turning on the presenter, the display 1 does not carry out corresponding page turning, and the page-turning trigger signal is continued to be monitored. Thereafter, for each time the page-turning trigger signal from the presenter is detected within the preset duration, the number of times of triggering of the page-turning trigger signal is increased by one until no page-turning trigger signal is detected within the preset duration, that is, until no page-turning trigger signal is obtained within the preset duration, the processor 3 stops counting the page-turning trigger signal, the display 1 exits the fast page-turning mode, and the number of times of triggering of the page-tuning trigger signal in this case is recorded, for example, the number of times of triggering of is m, and m is an integer not less than 2. Then, according to the number of times of triggering of the page-turning trigger signal, a target page corresponding to the number of times of triggering of is determined, and an indication signal for switching the content page that is currently displayed by the display 1 to a target page is generated. The content page and the target page are non-consecutive pages. In this way, the processor may switch the content page to the target page that is not continuous with the content page according to the indication signal, thereby ensuring page-turning efficiency.

In addition, in a specific implementation process, in a case that the number of times of triggering of the page-turning trigger signal is greater than the remaining total number of pages, the last content page in the remaining total number of pages is determined, the last content page is taken as the target page, and an indication signal for switching the content page that is currently displayed by the display 1 to the last content page is generated. In this way, the processor 3 may directly switch the content page that is currently displayed by the display 1 to the last content page according to the indication signal, such that a whole page-turning process more conforms to a usage habit of the user, wrong turning is avoided, and page-turning efficiency is improved.

In a specific implementation process, the processor 3 may determine a page number, corresponding to the number of times of triggering, of to which the content page of the display 1 is required to be switched according to a corresponding relation between a presentation page of the presenter and the content page of the display 1, for example, one presentation page corresponds to three prompt pages, and according to the number of times of triggering of the page-turning trigger signal of the presentation pages of the presenter. For example, in a case that one presentation page corresponds to three content pages, after the display 1 exits the fast page-turning mode, the display 1 turns pages with the number of pages of 3m from a nth page that is currently displayed, so as to implement fast page turning of the display 1. In addition, since the content page of the display 1 is not turned when fast page turning is carried out on the presenter, and after the display 1 exits the fast page-turning mode, the display 1 is switched from the content page that is currently displayed to the target page, page-turning efficiency is further improved.

In an embodiment of the present disclosure, in a case that the page-turning trigger signal includes the first trigger signal and the second trigger signal, the processor 3 configured to obtain the page-turning trigger signal, and process the page-turning trigger signal to obtain the indication signal is configured to: process the first trigger signal, and generate the indication signal for switching the content page to the target page.

In a specific implementation process, in a case that the processor 3 obtains both the first trigger signal sent from the page-turning terminal and the second trigger signal sent from the eye tracker 2, the processor 3 preferentially processes the first trigger signal, and generates the indication signal for switching the content page to the target page, such that the processor 3 may switch the content page that is currently displayed by the display 1 to the target page according to the indication signal. That is, in a case that the content page of the display 1 is turned through the page-turning terminal and the eye tracker 2, the page is turned preferentially through the page-turning terminal.

In an embodiment of the present disclosure, in a case that the network response duration is detected as longer than the preset duration, it is indicated that there is a network delay or network congestion in the teleprompter system currently. In this case, the content page is switched to the target page preferentially according to the second page-turning trigger signal sent by the eye tracker 2. The preset duration is a duration that is preset, and may be the preset duration according to an actual page-turning habit of the user. For example, the preset duration is 10 ms; and in an actual page-turning process, the network response duration is detected as 0.1 s, which is greater than 10 ms, such that it means that there is a network delay in the teleprompter system. In this way, the page may be turned by the eye tracker 2. In addition, in a process that the processor 3 switches the content page of the display 1 to the target page according to the second trigger signal sent from the eye tracker 2, in a case that eyes of the user watch the first preset region for representing the page-turning function in the content page and the watching duration is detected as longer than the preset duration, the content page of the display 1 is switched to the target page by watching the first preset region, thereby avoiding wrong switching of the content page, and improving prompt page-turning efficiency.

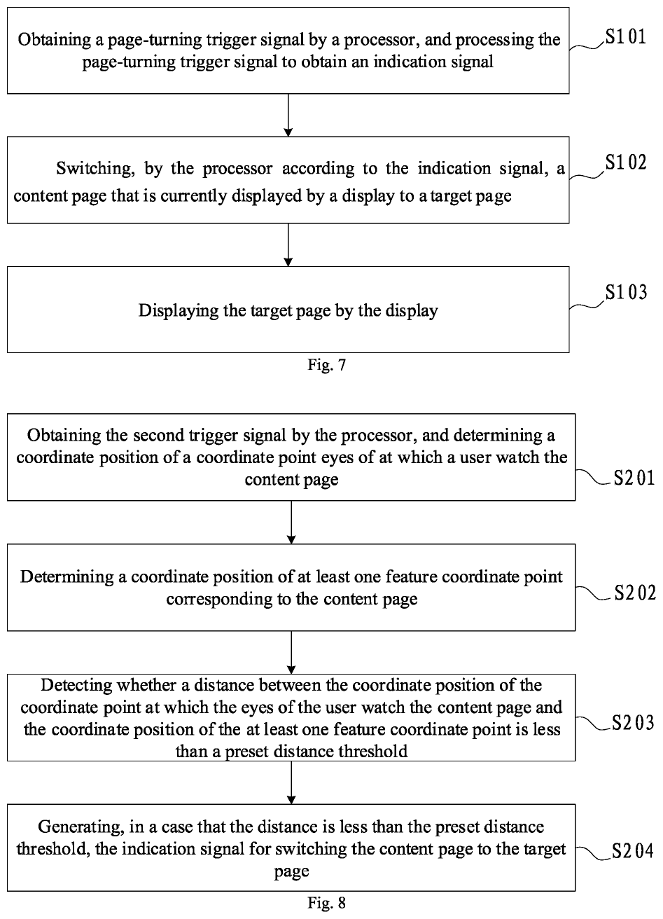

On the basis of the same inventive concept, as shown in FIG. 7, an embodiment of the present disclosure provides an operation method for a teleprompter system. The method includes:
S101: obtaining a page-turning trigger signal by a processor, and processing the page-turning trigger signal to obtain an indication signal;
S102: switching, by the processor according to the indication signal, a content page that is currently displayed by a display to a target page; and
S103: displaying the target page by the display.

A specific implementation process of step S101 to step S103 has been described in detail in the above description of the teleprompter system, and will not be repeated herein.

In an embodiment of the present disclosure, as shown in FIG. 8, in a case that the page-turning trigger signal is the second trigger signal, the step S101 of obtaining a page-turning trigger signal by a processor, and processing the page-turning trigger signal to obtain an indication signal includes:
S201: obtaining the second trigger signal by the processor, and determining a coordinate position of a coordinate point eyes of at which a user watch the content page;
S202: determining a coordinate position of at least one feature coordinate point corresponding to the content page;
S203: detecting whether a distance between the coordinate position of the coordinate point at which the eyes of the user watch the content page and the coordinate position of the at least one feature coordinate point is less than a preset distance threshold; and
S204: generating, in a case that the distance is less than the preset distance threshold, the indication signal for switching the content page to the target page.

In an embodiment of the present disclosure, the step S202 of determining a coordinate position of at least one feature coordinate point corresponding to the content page includes, but is not limited to, the following three implementation modes.

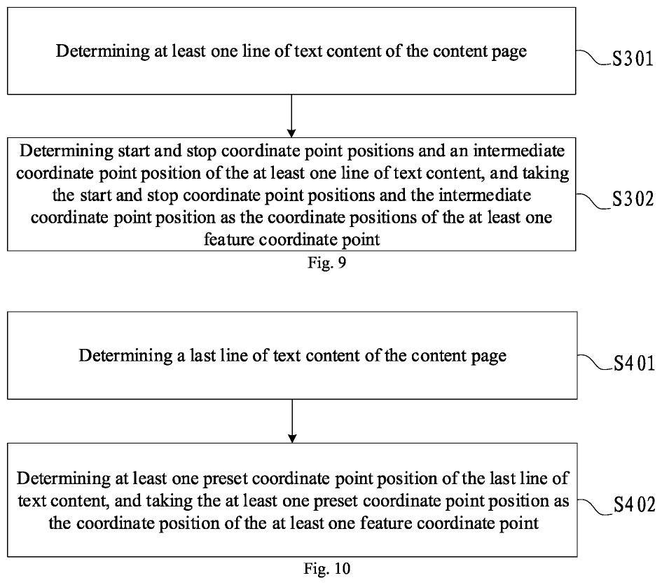

As shown in FIG. 9, a first implementation mode of the step S202 includes:
S301: determining at least one line of text content of the content page; and
S302: determining start and stop coordinate point positions and an intermediate coordinate point position of the at least one line of text content, and taking the start and stop coordinate point positions and the intermediate coordinate point position as the coordinate positions of the at least one feature coordinate point.

As shown in FIG. 10, a second implementation mode of the step S202 includes:
S401: determining a last line of text content of the content page; and
S402: determining at least one preset coordinate point position of the last line of text content, and taking the at least one preset coordinate point position as the coordinate position of the at least one feature coordinate point.

In a specific implementation process, after the steps S402 of determining at least one preset coordinate point position of the last line of text content, and taking the at least one preset coordinate point position as the coordinate position of the at least one feature coordinate point, the method further includes: scrolling the last line of text content of the content page to a first line of text content of the target page.

In an embodiment of the present disclosure, a third implementation mode of the step S202 includes: determining at least one key word of the content page and at least one coordinate position of the at least one key word on the content page, and taking the at least one coordinate position as the coordinate position of the at least one feature coordinate point.

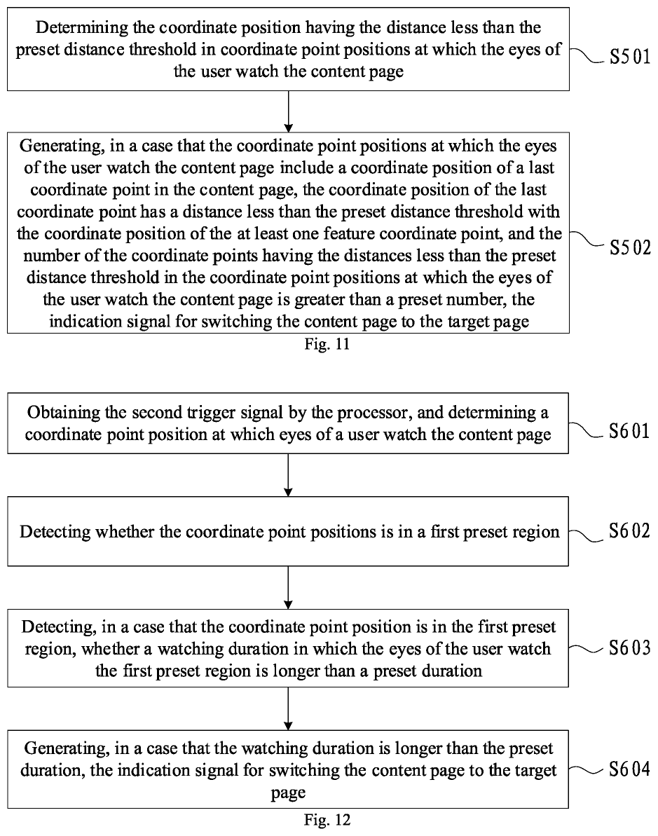

In an embodiment of the present disclosure, as shown in FIG. 11, after the step S203 of detecting whether a distance between the coordinate position of the coordinate point at which the eyes of the user watch the content page and the coordinate position of the at least one feature coordinate point is less than the preset distance threshold, the method further includes:
S501: determining the coordinate position having the distance less than the preset distance threshold in coordinate point positions at which the eyes of the user watch the content page; and
S502: generating, in a case that the coordinate point positions at which the eyes of the user watch the content page include a coordinate position of a last coordinate point in the content page, the coordinate position of the last coordinate point has a distance less than the preset distance threshold with the coordinate position of the at least one feature coordinate point, and the number of the coordinate points having the distances less than the preset distance threshold in the coordinate point positions at which the eyes of the user watch the content page is greater than a preset number, the indication signal for switching the content page to the target page.

In an embodiment of the present disclosure, in a case that the page-turning trigger signal is the second trigger signal, as shown in FIG. 12, the step S101 of obtaining a page-turning trigger signal by a processor, and processing the page-turning trigger signal to obtain an indication signal includes:
S601: obtaining the second trigger signal by the processor, and determining a coordinate point position at which eyes of a user watch the content page;
S602: detecting whether the coordinate point positions is in a first preset region;
S603: detecting, in a case that the coordinate point position is in the first preset region, whether a watching duration in which the eyes of the user watch the first preset region is longer than a preset duration; and
S604: generating, in a case that the watching duration is longer than the preset duration, the indication signal for switching the content page to the target page.

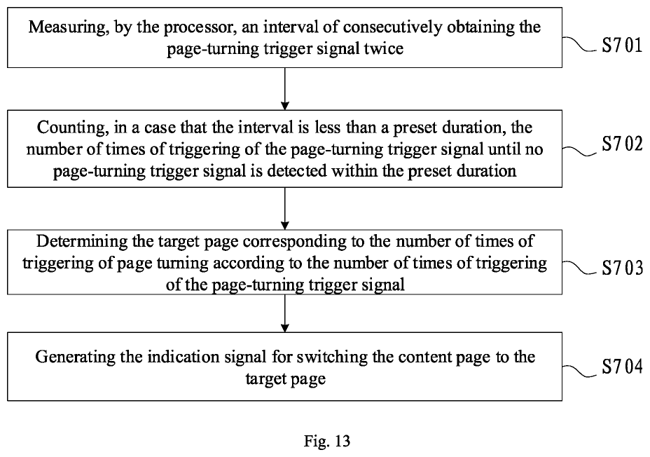

In an embodiment of the present disclosure, as shown in FIG. 13, the step S101 of obtaining a page-turning trigger signal by a processor, and processing the page-turning trigger signal to obtain an indication signal includes:
S701: measuring, by the processor, an interval of consecutively obtaining the page-turning trigger signal twice;
S702: counting, in a case that the interval is less than a preset duration, the number of times of triggering of the page-turning trigger signal until no page-turning trigger signal is detected within the preset duration;
S703: determining the target page corresponding to the number of times of triggering of page turning according to the number of times of triggering of the page-turning trigger signal; and
S704: generating the indication signal for switching the content page to the target page.

In an embodiment of the present disclosure, in a case that the page-turning trigger signal includes the first trigger signal and the second trigger signal, the step S101 of obtaining a page-turning trigger signal by a processor, and processing the page-turning trigger signal to obtain an indication signal includes: processing the first trigger signal by the processor, and generating the indication signal for switching the content page to the target page.

In a specific implementation process, the method steps involved in the operation method for a teleprompter system have been described in detail in the above description of the teleprompter system, and will not be repeated herein.

Those skilled in the art should understand that embodiments of the present disclosure may be provided as methods, systems, or computer program products. Therefore, the present disclosure may employ full hardware embodiments, full software embodiments, or software and hardware combined embodiments. Moreover, the present disclosure may take the form of a computer program product implemented on one or more computer usable storage media (including, but not limited to, disc memories, compact disc read-only memories (CD-ROMs), optical memories, etc.) including computer usable program codes.

The present disclosure is described with reference to flow diagrams and/or block diagrams of methods, devices (systems), and computer program products according to the present disclosure. It should be understood that each flow and/or block in the flow diagrams and/or block diagrams and combinations of the flows and/or blocks in the flow diagrams and/or block diagrams can be implemented by computer program instructions. These computer program instructions may be provided for a processor of a general-purpose computer, a special-purpose computer, an embedded processor, or other programmable data processing devices to produce a machine, such that instructions executed by the processor of the computer or other programmable data processing devices produce an apparatus configured to implement specified functions in one or more flows of each flow diagram and/or one or more blocks of each block diagram.

These computer program instructions may be stored in a computer readable memory that can guide a computer or other programmable data processing devices to work in a specific manner, such that the instructions stored in the computer readable memory produce an article of manufacture including an instruction apparatus, and the instruction apparatus implements specified functions in one or more flows of each flow diagram and/or one or more blocks in each block diagram.

These computer program instructions may be loaded onto a computer or other programmable data processing devices, such that a series of operation and steps are executed on the computer or other programmable devices generating computer-implemented processing. Therefore, the instructions executed on the computer or other programmable devices provide steps for implementing specific functions in one or more flows in each flow diagram and/or one or more blocks in each block diagram.

Although preferred embodiments of the present disclosure have been described, those skilled in the art can make additional changes and modifications to these embodiments once they learn the basic inventive concept. Therefore, the appended claims are intended to be interpreted as including preferred embodiments and all changes and modifications falling within the scope of the present disclosure.

Apparently, those skilled in the art can make various modifications and variations to the present disclosure without departing from the spirit and scope of the present disclosure. In this way, in the case that these modifications and variations of the present disclosure fall within the scope of the claims of the present disclosure and their equivalent technologies, the present disclosure is further intended to include these modifications and variations.

1. A teleprompter system, comprising a display, an eye tracker and a processor; wherein the processor is configured to:
obtain a page-turning trigger signal, and process the page-turning trigger signal to obtain an indication signal; and
switch a content page that is currently displayed by the display to a target page according to the indication signal, wherein the target page is displayed in the display;
wherein the page-turning trigger signal comprises at least one of:
a first trigger signal from a page-turning terminal in communication connection with the teleprompter system; or
a second trigger signal from the eye tracker.

2. The system according to claim 1, wherein in a case that the page-turning trigger signal is the second trigger signal, the processor configured to obtain the page-turning trigger signal, and process the page-turning trigger signal to obtain the indication signal is configured to:
obtain the second trigger signal, and determine a coordinate position of a coordinate point at which eyes of a user watch the content page;
determine a coordinate position of at least one feature coordinate point corresponding to the content page;
detect whether a distance between the coordinate position of the coordinate point at which the eyes of the user watch the content page and the coordinate position of the at least one feature coordinate point is less than a preset distance threshold; and
generate the indication signal for switching the content page to the target page in a case that the distance is less than the preset distance threshold.

3. The system according to claim 2, wherein the processor configured to determine the coordinate position of the at least one feature coordinate point corresponding to the content page is configured to:
determine at least one line of text content of the content page; and
determine start and stop coordinate point positions and an intermediate coordinate point position of the at least one line of text content, and take the start and stop coordinate point positions and the intermediate coordinate point position as the coordinate positions of the at least one feature coordinate point.

4. The system according to claim 2, wherein the processor configured to determine the coordinate position of the at least one feature coordinate point corresponding to the content page is configured to:
determine a last line of text content of the content page; and
determine at least one preset coordinate point position of the last line of text content, and take the at least one preset coordinate point position as the coordinate position of the at least one feature coordinate point.

5. The system according to claim 4, wherein after the processor is configured to determine the at least one preset coordinate point position of the last line of text content, and take the at least one preset coordinate point position as the coordinate position of the at least one feature coordinate point, the processor is further configured to:
scroll the last line of text content of the content page to a first line of text content of the target page.

6. The system according to claim 2, wherein the processor configured to determine the coordinate position of the at least one feature coordinate point corresponding to the content page is configured to:
determine at least one key word on the content page and at least one coordinate position of the at least one key word on the content page, and take the at least one coordinate position as the coordinate position of the at least one feature coordinate point.

7. The system according to claim 2, wherein after the processor is configured to detect whether the distance between the coordinate position of the coordinate point at which the eyes of the user watch the content page and the coordinate position of the at least one feature coordinate point is less than the preset distance threshold, the processor is further configured to:
determine the coordinate position having the distance less than the preset distance threshold in coordinate point positions at which the eyes of the user watch the content page; and
generate the indication signal for switching the content page to the target page in a case that the coordinate point positions at which the eyes of the user watch the content page comprise a coordinate position of a last coordinate point in the content page, the coordinate position of the last coordinate point has a distance less than the preset distance threshold with the coordinate position of the at least one feature coordinate point, and a quantity of the coordinate positions having the distances less than the preset distance threshold in the coordinate point positions at which the eyes of the user watch the content page is greater than a preset number.

8. The system according to claim 1, wherein in a case that the page-turning trigger signal is the second trigger signal, the processor configured to obtain the page-turning trigger signal, and process the page-turning trigger signal to obtain the indication signal is configured to:
obtain the second trigger signal, and determine a coordinate point position at which eyes of a user watch the content page;
detect whether the coordinate point position is in a first preset region;
detect, in a case that the coordinate point position is in the first preset region, whether a watching duration in which the eyes of the user watch the first preset region is longer than a preset duration; and
generate, in a case that the watching duration is longer than the preset duration, the indication signal for switching the content page to the target page.

9. The system according to claim 1, wherein the processor configured to obtain the page-turning trigger signal, and process the page-turning trigger signal to obtain the indication signal is configured to:
measure an interval of consecutively obtaining the page-turning trigger signal twice;
count, in a case that the interval is less than a preset duration, a number of times of triggering of the page-turning trigger signal until no page-turning trigger signal is detected within the preset duration;
determine the target page corresponding to the number of times of triggering of the page-turning trigger signal according to the number of times of triggering of the page-turning trigger signal; and
generate the indication signal for switching the content page to the target page.

10. The system according to claim 1, wherein in a case that the page-turning trigger signal comprises the first trigger signal and the second trigger signal, the processor configured to obtain a page-turning trigger signal, and process the page-turning trigger signal to obtain the indication signal is configured to:
process the first trigger signal, and generate the indication signal for switching the content page to the target page.

11. An operation method for a teleprompter system, comprising:
obtaining a page-turning trigger signal by a processor, and processing the page-turning trigger signal to obtain an indication signal;
switching, by the processor according to the indication signal, a content page that is currently displayed by a display to a target page; and
displaying the target page by the display;
wherein the page-turning trigger signal comprises at least one of:
a first trigger signal from a page-turning terminal in communication connection with the teleprompter system; and
a second trigger signal from an eye tracker.

12. The method according to claim 11, wherein in a case that the page-turning trigger signal is the second trigger signal, the obtaining the page-turning trigger signal by a processor, and the processing the page-turning trigger signal to obtain the indication signal comprise:
obtaining the second trigger signal by the processor, and determining a coordinate position of a coordinate point at which eyes of a user watch the content page;
determining a coordinate position of at least one feature coordinate point corresponding to the content page;
detecting whether a distance between the coordinate position of the coordinate point at which the eyes of the user watch the content page and the coordinate position of the at least one feature coordinate point is less than a preset distance threshold; and
generating the indication signal for switching the content page to the target page in a case that the distance is less than the preset distance threshold.

13. The method according to claim 12, wherein the determining the coordinate position of the at least one feature coordinate point corresponding to the content page comprises:
determining at least one line of text content of the content page; and
determining start and stop coordinate point positions and an intermediate coordinate point position of the at least one line of text content, and taking the start and stop coordinate point positions and the intermediate coordinate point position as the coordinate positions of the at least one feature coordinate point.

14. The method according to claim 12, wherein the determining the coordinate position of at least one feature coordinate point corresponding to the content page comprises:
determining a last line of text content of the content page; and
determining at least one preset coordinate point position of the last line of text content, and taking the at least one preset coordinate point position as the coordinate position of the at least one feature coordinate point.

15. The method according to claim 14, wherein after determining at least one preset coordinate point position of the last line of text content, and taking the at least one preset coordinate point position as the coordinate position of the at least one feature coordinate point, the method further comprises:
scrolling the last line of text content of the content page to a first line of text content of the target page.

16. The method according to claim 12, wherein the determining the coordinate position of at least one feature coordinate point corresponding to the content page comprises:
determining at least one key word of the content page and at least one coordinate position of the at least one key word on the content page, and taking the at least one coordinate position as the coordinate position of the at least one feature coordinate point.

17. The method according to claim 12, wherein after detecting whether the distance between the coordinate position of the coordinate point at which the eyes of the user watch the content page and the coordinate position of the at least one feature coordinate point is less than the preset distance threshold, the method further comprises:
determining the coordinate position having the distance less than the preset distance threshold in coordinate point positions at which the eyes of the user watch the content page; and
generating the indication signal for switching the content page to the target page, in a case that the coordinate point positions at which the eyes of the user watch the content page comprise a coordinate position of a last coordinate point in the content page, the coordinate position of the last coordinate point has a distance less than the preset distance threshold with the coordinate position of the at least one feature coordinate point, and a quantity of the coordinate positions having the distances less than the preset distance threshold in the coordinate point positions at which the eyes of the user watch the content page is greater than a preset number.

18. The method according to claim 11, wherein in a case that the page-turning trigger signal is the second trigger signal, the obtaining the page-turning trigger signal by the processor, and the processing the page-turning trigger signal to obtain the indication signal comprise:
obtaining the second trigger signal by the processor, and determining a coordinate point position at which eyes of a user watch the content page;
detecting whether the coordinate point position is in a first preset region;
detecting, in a case that the coordinate point position is in the first preset region, whether a watching duration in which the eyes of the user watch the first preset region is longer than a preset duration; and
generating, in a case that the watching duration is longer than the preset duration, the indication signal for switching the content page to the target page.

19. The method according to claim 11, wherein the obtaining the page-turning trigger signal by the processor, and the processing the page-turning trigger signal to obtain the indication signal comprise:
measuring, by the processor, an interval of consecutively obtaining the page-turning trigger signal twice;
counting, in a case that the interval is less than a preset duration, a number of times of triggering of the page-turning trigger signal until no page-turning trigger signal is detected within the preset duration;
determining the target page corresponding to the number of times of triggering of the page-turning trigger signal according to the number of times of triggering of the page-turning trigger signal; and
generating the indication signal for switching the content page to the target page.

20. The method according to claim 11, wherein in a case that the page-tuning trigger signal comprises the first trigger signal and the second trigger signal, the obtaining the page-turning trigger signal by a processor, and the processing the page-turning trigger signal to obtain the indication signal comprise:
processing the first trigger signal by the processor, and generating the indication signal for switching the content page to the target page.
